(19) United States
(12) Patent Application Publication
(10) Pub. No.: US 2018/0293192 A1
(43) Pub. Date: Oct. 11, 2018

(54) Multi-Memory Collaboration Structure Based on SPI Interface

(71) Applicant: Lyontek Inc., Hsinchu City (TW)

(72) Inventors: CHI-CHENG HUNG, Hsinchu City (TW); TZU-CHING CHUEH, Taipei City (TW); PENG-JU HUANG, Miaoli County (TW)

(21) Appl. No.: 15/792,057

(22) Filed: Oct. 24, 2017

(30) Foreign Application Priority Data
Apr. 11, 2017 (TW) 106112073

(51) Int. Cl. G06F 13/16; G06F 3/06; G06F 13/42; G06F 12/02; G06F 12/06

(52) U.S. Cl. CPC G06F 13/1694; G06F 3/0604; G06F 3/0659; G06F 3/0685; G06F 2212/205; G06F 12/0238; G06F 12/0638; G06F 13/4234; G06F 13/4282

(57) ABSTRACT

A multi-memory collaboration structure based on SPI interface is provided, including a first memory, a second memory, and a control module. In an embodiment, instruction codes of first actuating commands transmitted from the control module to the first memory are different from those of second actuating commands transmitted from the control module to the second memory. In another embodiment, a first actuating command has a preselected instruction code and an alternate instruction code, and a second actuating command has a second instruction code, wherein the preselected instruction code is different from the alternate instruction code, and at least one of the preselected instruction code and the alternate instruction code is different from the second instruction code. Therefore, the invention only requires one chip select port to avoid signal conflict between different memories, thereby effectively reducing the fabrication costs.

### CROSS-REFERENCE TO RELATED APPLICATIONS

This application claims the priority of Republic of China Patent Application No. 106112073 filed on Apr. 11, 2017, in the State Intellectual Property Office of the R.O.C., the disclosure of which is incorporated herein by reference.

### BACKGROUND OF THE INVENTION

### Field of the Invention

The invention relates to a multi-memory collaboration structure based on SPI (Serial Peripheral Interface Bus) interface, and more particularly, to a multi-memory collaboration structure that only requires one chip select port.

### Descriptions of the Related Art

Wide application of miniaturized electronic devices (such as wearable electronic devices) has made a multi-chip package structure, which may integrate a plurality of memories in a single package, become more and more popular in the market for its advantages such as small product size and low fabrication costs.

MCP (Multi Chip Package) involves a new technology developed from semiconductor system level packaging and multi-chip packaging technologies. MCP may stack different types of memories to form one MCP chip (for example, 1 Mb SPI SRAM+1 Mb SPI flash), which is applicable in various hand-held and miniaturized electronic products such as intelligent wearing device, digital camera, digital video camera, smart phone, satellite navigation system and tablet computer, etc.

If two or more SPI memory chips are directly integrated in a single package structure, however, what usually happens is it is difficult to determine which SPI memory chip is executing an access operation and thereby causes device conflict between the chips. In such a case, providing that a single MCP structure has two or more SPI memory chips, which means its SPI I/O bus is connected to two or more SPI memory chips, a corresponding chip select pin must be provided respectively for each of the SPI memory chips, in order to determine which SPI memory chip is executing the access operation.

Particularly referring to FIG. 1, which shows a conventional multi-memory collaboration structure 10 (that is, the above MCP chip). The multi-memory collaboration structure 10 includes a first memory 11a, a second memory 11b, a third memory 11c and a control module 13. The control module 13 includes a plurality of communication ports 132, and a plurality of CS ports 131a, 131b, 131c provided respectively corresponding to the memories as a plurality of chip select pins. As shown in FIG. 1, the CS port (CS1) 131a is connected to the first memory 11a, the CS port (CS2) 131b is connected to the second memory 11b, and the CS port (CS3) 131c is connected to the third memory 11c, in order to prevent signal conflict between different memories. This design of structure however must increase the chip package size and may also raise its fabrication costs.

Therefore, how to solve the above problems in the conventional technology is an important task in the art.

### SUMMARY OF THE INVENTION

In view of the above and other drawbacks of the conventional technology, a primary object of the invention is to provide a multi-memory collaboration structure based on SPI interface, which requires only one chip select port to be able to effectively prevent signal conflict between different memories

Another object of the invention is to provide a multi-memory collaboration structure based on SPI interface, which may reduce the fabrication costs and reduce the package size.

For the objects said above and for other objects, the first embodiment of the invention provides a multi-memory collaboration structure based on SPI interface, including: at least one first memory; at least one second memory; and a control module having one chip select port and at least one control IO (Input/Output) port, wherein, the chip select port is connected to an end of a communication line, and the communication line has other ends connected to the first memory and the second memory respectively, so as to selectively enable the first memory and the second memory; and the control IO port is for providing a plurality of first actuating commands and a plurality of second actuating commands, wherein the first actuating commands are respectively transmitted to the first memory so as to allow the first memory to accordingly perform corresponding actions, and the second actuating commands are respectively transmitted to the second memory so as to allow the second memory to accordingly perform corresponding actions, wherein the plurality of first actuating commands have instruction codes different from those of the plurality of second actuating commands.

Furthermore, the second embodiment of the invention provides a multi-memory collaboration structure based on SPI interface, including: at least one first memory; at least one second memory; and a control module having one chip select port and at least one control IO port, wherein, the chip select port is connected to an end of a communication line, and the communication line has other ends connected to the first memory and the second memory respectively, so as to selectively enable the first memory and the second memory; and the control IO port is for providing a first actuating command and a second actuating command, wherein the first actuating command is transmitted to the first memory so as to allow the first memory to accordingly perform a corresponding action, and the second actuating command is transmitted to the second memory so as to allow the second memory to accordingly perform a corresponding action, wherein the first actuating command has a preselected instruction code and an alternate instruction code, and the second actuating command has a second instruction code, wherein the preselected instruction code is different from the alternate instruction code, and at least one of the preselected instruction code and the alternate instruction code is different from the second instruction code.

Optionally, for the multi-memory collaboration structure of the second embodiment of the invention said above, wherein further including a determining module for determining if the preselected instruction code is same as the second instruction code, wherein if the preselected instruction code is same as the second instruction code, the control IO port is allowed to choose the alternate instruction code as an instruction code for the first actuating command and transmit the first actuating command to the first memory such that the first memory receives the first actuating command and accordingly performs the corresponding action.

Optionally, for the multi-memory collaboration structure of the second embodiment of the invention said above, wherein the control IO port is further for providing a third actuating command that is for choosing the preselected instruction code or the alternate instruction code as an instruction code for the first actuating command, so as to transmit the first actuating command to the first memory, and allow the first memory to receive the first actuating command and accordingly perform the corresponding action.

Optionally, for the multi-memory collaboration structure of the second embodiment of the invention said above, wherein the first memory further includes a memory module for storing one of the preselected instruction code and the alternate instruction code corresponding to the first actuating command, such that when the first memory receives the first actuating command transmitted from the control IO port, it retrieves the preselected instruction code or the alternate instruction code from the memory module to identify the first actuating command and accordingly perform the corresponding action. the memory module is a selective fuse or a non-volatile memory.

Optionally, for the multi-memory collaboration structure of the first or second embodiment of the invention said above, wherein the first memory is a random access memory and the second memory is a non-volatile memory.

Optionally, for the multi-memory collaboration structure of the first or second embodiment of the invention said above, wherein each of the first and second memories is a random access memory or a non-volatile memory.

Optionally, for the multi-memory collaboration structure of the first or second embodiment of the invention said above, wherein the at least one first memory includes a plurality of first memories, and the at least one second memory includes a plurality of second memories.

Optionally, for the multi-memory collaboration structure of the first or second embodiment of the invention said above, wherein the first and second memories are packaged in a single MCP (Multi Chip Package) structure.

Optionally, for the multi-memory collaboration structure of the first or second embodiment of the invention said above, wherein the SPI interface is a DUAL SPI interface or a QUAD SPI interface.

Compared to the conventional technology, the invention is to provide a multi-memory collaboration structure based on SPI interface. In a first embodiment of the invention, instruction codes corresponding to a plurality of first actuating commands that control a first memory to operate are made different from those corresponding to a plurality of second actuating commands that control a second memory to operate. In a second embodiment of the invention, a first actuating command that controls a first memory to operate is provided with a preselected instruction code and an alternate instruction code. The preselected instruction code is different from the alternate instruction code. At least one of the preselected instruction code and the alternate instruction code is different from a second instruction code for a second actuating command that controls a second memory to operate. This allows the multi-memory collaboration structure based on SPI interface of the invention to merely require one chip select port to prevent signal conflict between different memories, thereby reducing the fabrication costs.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram showing a basic architecture of a conventional multi-memory collaboration structure based on SPI interface;

FIG. 2 is a schematic diagram showing a basic architecture of a multi-memory collaboration structure based on SPI interface according to first and second embodiments of the invention;

FIG. 3 is a schematic diagram showing data transmission between a control module and first and second memories according to the first embodiment of the invention;

FIG. 4 is a schematic diagram showing instruction codes according to the second embodiment of the invention; and

FIGS. 5A to 5C are schematic diagrams showing various ways of implementation of choosing a preselected instruction code or an alternate instruction code as an instruction code for a first actuating command according to the second embodiment of the invention.

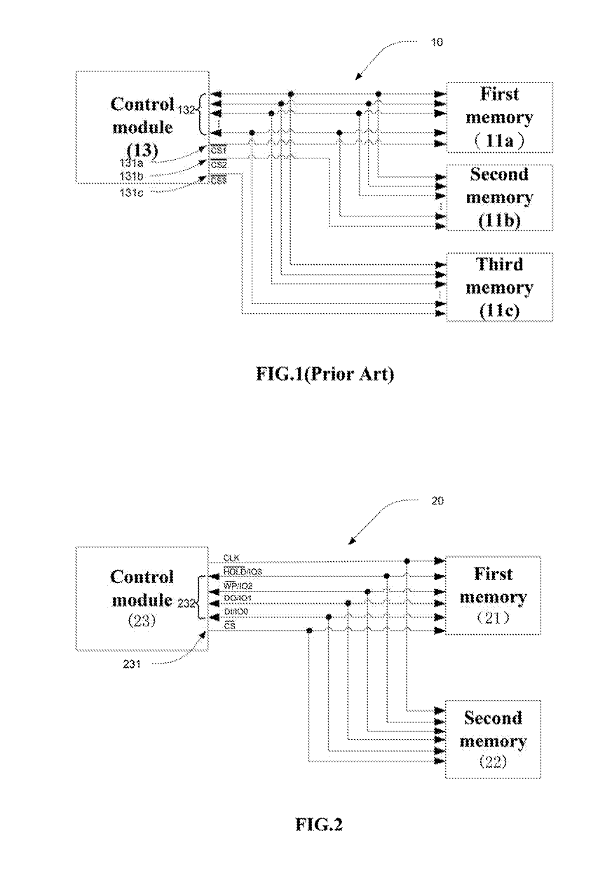

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

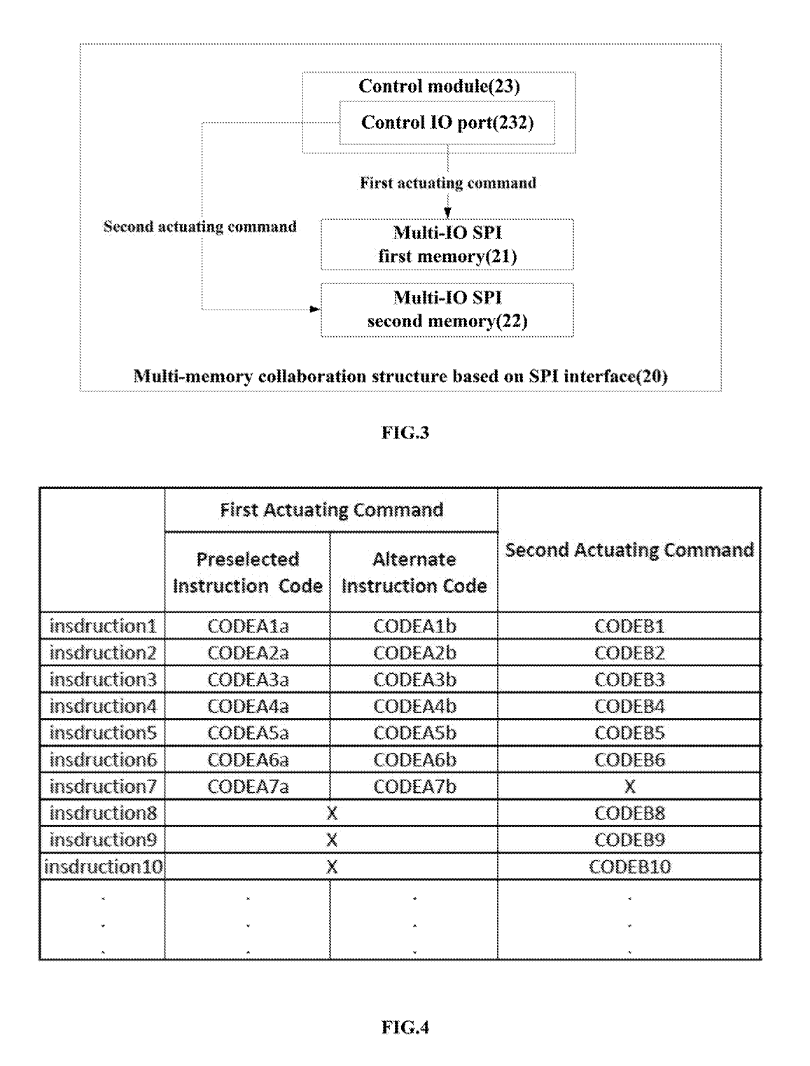

Referring to FIGS. 2 and 3, FIG. 2 is a schematic diagram showing a basic architecture of a multi-memory collaboration structure based on SPI interface according to first and second embodiments of the invention, and FIG. 3 is a schematic diagram showing data transmission between a control module and first and second memories according to the first embodiment of the invention. In the first embodiment of the invention, the multi-memory collaboration structure based on SPI interface 20 includes at least one first memory 21, at least one second memory 22, and a control module 23.

As shown in FIG. 2, the first memory 21 and the second memory 22 are packaged in a single MCP structure, wherein for example, the first memory 21 is a random access memory and the second memory 22 is a non-volatile memory. This does not set any limitation to the invention. In another embodiment, the first memory 21 and the second memory 22 can each be a non-volatile memory or a random access memory. Further, the number of each of the first and second memories 21, 22 can be one or more, depending on practical requirements. Either of the first and/or second memories 21, 22 can be a Multi-IO SPI memory (as shown in FIG. 3). The multi-memory collaboration structure 20 is based on a Multi-IO SPI interface, such as DUAL SPI interface or QUAD SPI interface.

The control module 23 includes a chip select port 231 and a plurality of control IO ports 232, wherein only one chip select port (CS) 231 is provided in this embodiment and is connected to one end of a communication line. The communication line has other ends connected to the first memory 21 and the second memory 22 respectively, for selectively enabling the first memory 21 or the second memory 22. The control IO ports 232 include, as shown in FIG. 2, DI(IO0) port, DO(IO1) port, WP(IO2) port and/or HOLD(IO3) port, for providing a plurality of first actuating commands and a plurality of second actuating commands. In the first embodiment of the invention, the plurality of first actuating commands have instruction codes different from those of the plurality of second actuating commands.

Particularly referring to FIG. 3, the control module 23 transmits the plurality of first actuating commands to the first memory 21 through the control IO ports 232, such that the first memory 21 receives the plurality of first actuating commands and performs corresponding actions according to the received first actuating commands, for example, data reading/writing. Similarly, the control module 23 transmits the plurality of second actuating commands to the second memory 22 through the control IO ports 232, such that the second memory 22 receives the plurality of second actuating commands and performs corresponding actions according to the received second actuating commands. The plurality of first actuating commands transmitted to the first memory 21 and the plurality of second actuating commands transmitted to the second memory 22 may be partly the same, for example, the first and second actuating commands both transmitted through DI(IO0) port, DO(IO1) port, WP(IO2) port and/or HOLD(IO3) port shown in FIG. 2 are the same. In such a case, the plurality of first actuating commands have their corresponding instruction codes different from those corresponding to the plurality of second actuating commands in the invention. Thus, even if the first actuating commands transmitted to the first memory and the second actuating commands transmitted to the second memory through the control IO ports 232 (including the above DI(IO0) port, DO(IO1) port, WP(IO2) port and/or HOLD(IO3) port) are the same, as the instruction codes corresponding to the first actuating commands are different from those corresponding to the second actuating commands, only one chip select port 231 is able to identify the first actuating commands transmitted to the first memory and the second actuating commands transmitted to the second memory, thereby avoiding signal conflict between the first memory 21 and the second memory 22.

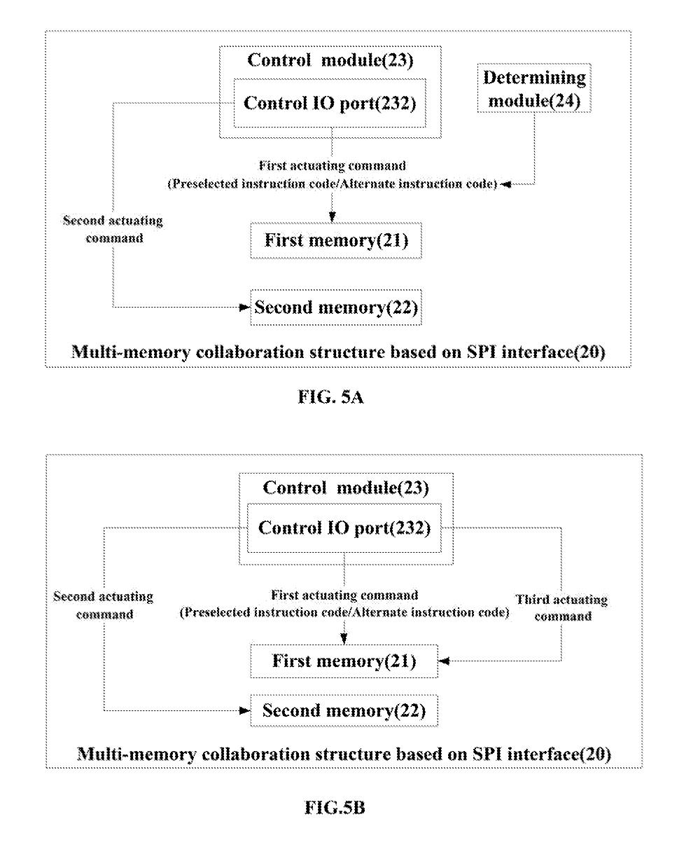

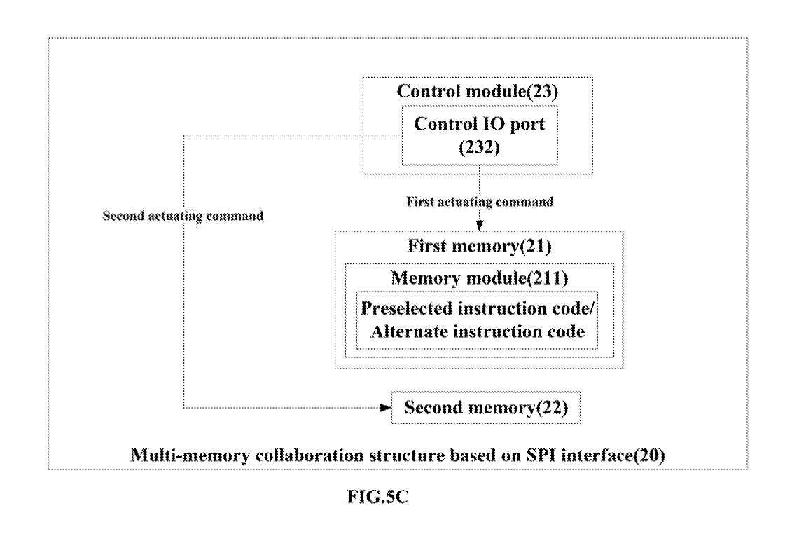

Referring to FIGS. 2, 4 and 5A to 5C, FIG. 4 is a schematic diagram showing instruction codes according to the second embodiment of the invention, and FIGS. 5A and 5B are schematic diagrams showing various ways of implementation of choosing a preselected instruction code or an alternate instruction code as an instruction code for a first actuating command according to the second embodiment of the invention. The second embodiment of the invention is similar to the above first embodiment in that, the multi-memory collaboration structure based on SPI interface 20 includes at least one first memory 21, at least one second memory 22, and a control module 23, wherein the first memory 21 and the second memory 22 are packaged in a single MCP structure. The first memory 21 and the second memory 22 are each a non-volatile memory or a random access memory. This does not set any limitation to the invention. Preferably, the first memory 21 is a random access memory and the second memory 22 is a non-volatile memory. It is also flexible to have multiple first memories 21 and multiple second memories 22. The SPI interface can be a DUAL SPI interface or a QUAD SPI interface.

Further referring to FIG. 2, similarly in this embodiment the control module 23 includes a chip select port 231 and a plurality of control IO ports 232, wherein only one chip select port (CS) 231 is provided and is connected to one end of a communication line. The communication line has other ends connected to the first memory 21 and the second memory 22 respectively, for selectively enabling the first memory 21 and the second memory 22. The control IO ports 232 include, DI(IO0) port, DO(IO1) port, WP(IO2) port and/or HOLD(IO3) port as shown in FIG. 2, for providing at least one first actuating command and at least one second actuating command.

As shown in FIG. 5A or 5C, the control module 23 transmits the first actuating command to the first memory 21 through the control IO ports 232, so as to allow the first memory 21 to perform a corresponding action according to the first actuating command, for example, data reading/writing; the control module 23 transmits the second actuating command to the second memory 22 through the control IO ports 232, so as to allow the second memory 22 to perform a corresponding action according to the second actuating command. The second embodiment differs from the first embodiment in that, the first actuating command in the second embodiment is provided with a preselected instruction code and an alternate instruction code (as shown in FIG. 4), wherein the preselected instruction code is different from the alternate instruction code, and at least one of the preselected instruction code and the alternate instruction code corresponding to the first actuating command is different from a second instruction code corresponding to the second actuating command. This allows the first actuating command and the second actuating command to be differentiated from each other and thereby requires only one chip select port 231 that is able to avoid signal conflict between the first memory 21 and the second memory 22. Moreover, the invention may use various ways to choose the preselected instruction code or the alternate instruction code as a corresponding instruction code for the first actuating command, a few of which are embodied as described below. It should be understood that, the invention is not limited to the following ways of implementation but may also be implemented in other ways by those skilled in the art.

Referring to FIG. 5A, in a first way of implementation, the multi-memory collaboration structure 20 further includes a determining module 24 for determining if the preselected instruction code is same as the second instruction code. If yes, the control IO ports 232 are allowed to choose the alternate instruction code as an instruction code for the first actuating command, making the first actuating command have a different instruction code from that of the second actuating command. The first actuating command is then transmitted to the first memory 21, and the first memory 21 receives the first actuating command and accordingly performs a corresponding action. This thereby avoids signal conflict between the first memory 21 and the second memory 22.

Referring to FIG. 5B, in a second way of implementation, the control IO ports 232 further provide a third actuating command for allowing the control module 23 to choose the preselected instruction code or the alternate instruction code as an instruction code for the first actuating command, so as to make the first actuating command and the second actuating command have different instruction codes. In particular, the first memory 21 may receive the third actuating command to identify whether the instruction code for the first actuating command chosen by the control IO ports 232 is the preselected instruction code or the alternate instruction code. Thus, when the control IO ports 232 transmit the first actuating command to the first memory 21, the first memory 21 may receive the first actuating command and perform a corresponding action according to the first actuating command.

Referring to FIG. 5C, in a third way of implementation, the first memory 21 further includes a memory module 211 for storing one of the preselected instruction code and the alternate instruction code corresponding to the first actuating command. Thereby, when the first memory 21 receives the first actuating command transmitted from the control IO ports 232, it retrieves the preselected or alternate instruction code stored in the memory module 211 (the retrieved preselected or alternate instruction code is different from the second instruction code) to accordingly identify the first actuating command being received and perform a corresponding action. Preferably, the memory module 211 is, for example, a selective fuse or a non-volatile memory.

Therefore, the invention provides a multi-memory collaboration structure based on SPI interface. In a first embodiment of the invention, instruction codes corresponding to a plurality of first actuating commands that control a first memory to operate are made different from those corresponding to a plurality of second actuating commands that control a second memory to operate, such that the first actuating commands are distinguished from the second actuating commands. In a second embodiment of the invention, a preselected instruction code and an alternate instruction code are provided for a first actuating command. The preselected instruction code is different from the alternate instruction code. In the case that the preselected instruction code is same as a second instruction code corresponding to a second actuating command, the alternate instruction code is chosen as an instruction code for the first actuating command, so as to distinguish the first actuating command and the second actuating command. The multi-memory collaboration structure of the invention requires only one chip select port to be able to effectively prevent signal conflict between different memories, thereby simplifying the device structures and reducing the fabrication costs.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A multi-memory collaboration structure based on SPI (Serial Peripheral Interface Bus) interface, including:
at least one first memory;
at least one second memory; and
a control module having one chip select port and at least one control IO (Input/Output) port, wherein,
the chip select port is connected to an end of a communication line, and the communication line has other ends connected to the first memory and the second memory respectively, so as to selectively enable the first memory and the second memory; and
the control IO port is for providing a plurality of first actuating commands and a plurality of second actuating commands, wherein the first actuating commands are respectively transmitted to the first memory so as to allow the first memory to accordingly perform corresponding actions, and the second actuating commands are respectively transmitted to the second memory so as to allow the second memory to accordingly perform corresponding actions, wherein the plurality of first actuating commands have instruction codes different from those of the plurality of second actuating commands.

2. A multi-memory collaboration structure based on SPI interface, including:
at least one first memory;
at least one second memory; and
a control module having one chip select port and at least one control IO port, wherein,
the chip select port is connected to an end of a communication line, and the communication line has other ends connected to the first memory and the second memory respectively, so as to selectively enable the first memory and the second memory; and
the control IO port is for providing a first actuating command and a second actuating command, wherein the first actuating command is transmitted to the first memory so as to allow the first memory to accordingly perform a corresponding action, and the second actuating command is transmitted to the second memory so as to allow the second memory to accordingly perform a corresponding action, wherein the first actuating command has a preselected instruction code and an alternate instruction code, and the second actuating command has a second instruction code, wherein the preselected instruction code is different from the alternate instruction code, and at least one of the preselected instruction code and the alternate instruction code is different from the second instruction code.

3. The multi-memory collaboration structure according to claim 2, further including a determining module for determining if the preselected instruction code is same as the second instruction code, wherein if the preselected instruction code is same as the second instruction code, the control IO port is allowed to choose the alternate instruction code as an instruction code for the first actuating command and transmit the first actuating command to the first memory such that the first memory receives the first actuating command and accordingly performs the corresponding action.

4. The multi-memory collaboration structure according to claim 2, wherein the control IO port is further for providing a third actuating command that is for choosing the preselected instruction code or the alternate instruction code as an instruction code for the first actuating command, so as to transmit the first actuating command to the first memory, and allow the first memory to receive the first actuating command and accordingly perform the corresponding action.

5. The multi-memory collaboration structure according to claim 2, wherein the first memory further includes a memory module for storing one of the preselected instruction code and the alternate instruction code corresponding to the first actuating command, such that when the first memory receives the first actuating command transmitted from the control IO port, it retrieves the preselected instruction code or the alternate instruction code from the memory module to identify the first actuating command and accordingly perform the corresponding action.

6. The multi-memory collaboration structure according to claim 5, wherein the memory module is a selective fuse or a non-volatile memory.

7. The multi-memory collaboration structure according to claim 1, wherein the first memory is a random access memory and the second memory is a non-volatile memory.

8. The multi-memory collaboration structure according to claim 1, wherein each of the first and second memories is a random access memory or a non-volatile memory.

9. The multi-memory collaboration structure according to claim 1, wherein the at least one first memory includes a plurality of first memories, and the at least one second memory includes a plurality of second memories.

10. The multi-memory collaboration structure according to claim 1, wherein the first and second memories are packaged in a single MCP (Multi Chip Package) structure.

11. The multi-memory collaboration structure according to claim 1, wherein the SPI interface is a DUAL SPI (Serial Peripheral Interface Bus) interface or a QUAD SPI (Serial Peripheral Interface Bus) interface.

12. The multi-memory collaboration structure according to claim 2, wherein the first memory is a random access memory and the second memory is a non-volatile memory.

13. The multi-memory collaboration structure according to claim 2, wherein each of the first and second memories is a random access memory or a non-volatile memory.

14. The multi-memory collaboration structure according to claim 2, wherein the at least one first memory includes a plurality of first memories, and the at least one second memory includes a plurality of second memories.

15. The multi-memory collaboration structure according to claim 2, wherein the first and second memories are packaged in a single MCP (Multi Chip Package) structure.

16. The multi-memory collaboration structure according to claim 2, wherein the SPI interface is a DUAL SPI (Serial Peripheral Interface Bus) interface or a QUAD SPI (Serial Peripheral Interface Bus) interface.
